(19) United States
(12) Patent Application Publication
(10) Pub. No.: US 2004/0105104 A1
(43) Pub. Date: Jun. 3, 2004

(54) Image-processing apparatus and image-processing system

(75) Inventors: Tetsuya Ishikawa, Tokyo (JP); Tomohiro Suzuki, Tokyo (JP); Yuji Tamura, Tokyo (JP); Tadashi Sumi, Tokyo (JP); Tomoya Ogawa, Tokyo (JP); Fumikage Uchida, Asaka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/723,715

(22) Filed: Nov. 25, 2003

(30) Foreign Application Priority Data
Dec. 2, 2002 (JP) JP2002-349715
Feb. 13, 2003 (JP) JP2003-035505

(51) Int. Cl. G06F 15/00; G06F 3/12; G06F 13/38; G06F 13/12; H04N 1/40

(52) U.S. Cl. 358/1.6; 358/1.13; 358/1.15; 709/246; 710/65; 358/471

(57) ABSTRACT

There is described an image-processing system, which make it possible to effectively utilize the network environment, and in which the efficiency and the flexibility of the whole system are improved. The system is provided with an image-processing apparatus, which includes an image-reading section to read an image on a document, a first network interface to couple the image-processing apparatus to the network, and a general-purpose image format converting section to convert scanner data, acquired by reading the image on the document by means of a scanner included in the image-reading section, or PDL data, inputted through the network interface coupled to the network, to data of a same general-purpose image format, and an information-processing apparatus, which includes a second network interface to couple the information-processing apparatus to the network, and a display section to display a reproduced image based on the data of the general-purpose image format.

### BACKGROUND OF THE INVENTION

The present invention relates to an image-processing apparatus and an image-processing system, and specifically relates to an image-processing apparatus having an image-recording means and an image-processing system constituted by coupling the image-processing apparatus, an image-printing apparatus, an information processing apparatus, etc. to each other in a network.

Conventionally, there has been well known an image-processing apparatus, such as a scanner, etc., that is provided with an image-reading means for acquiring scanner data by reading an image from a document on which the image is recorded and an image-processing means for applying various kinds of image-processing operations to the scanner data.

Further, there has been well known an image-processing system in a network environment, in which the image-printing apparatus, such as a printer, etc., and an information processing apparatus such as a personal computer, etc., are coupled to each other so as to communicate with each other by coupling the image-processing apparatus to the network, like the network scanner.

Still further, for this kind of network system, it has been desired to construct a system having higher utility values by coupling the network to a plurality of other network systems.

For instance, in “Printing apparatus and Network Printing system” set forth in Patent Document 1 listed later, the printing apparatus coupled to the client computer through the network converts the PDL (Page Description Language, which can be interpreted by the image-printing apparatus by means of software called as an application program or a printer driver) data to the data of general-purpose image format, such as the PDF (Portable Document Format; file format for realizing communications with digital documents, developed by Adobe Systems Inc. in United States of America) data, the postscript, etc., and further, is provided with the control section to convert them to the pixel map data, the storage device to store the data of general-purpose image format in it, the image memory to develop the pixel map data, and the printer engine to print the pixel map data onto a sheet, so that the data of general-purpose image format can be also read from the external computer and utilized for the displaying and reprinting the reproduced image.

Further, in “Image-inputting apparatus and Image-inputting method” set forth in Patent Document 2 listed later, the data converting section converts the image data acquired in the image data generating section to the printing data by means of the printer driver suitable for the printer of the output destination, so as to make it possible to output them to either the network printer or the local printer through the outputting section. Still further, by converting the image data to the printing data at the site of the network scanner, it becomes possible to obtain the copy without going through the client's personal computer, resulting in a simplification of the operations. In addition, it becomes possible to obtain the copy by employing the scanner without increasing the traffics on the network.

Patent Document 1: Tokkai 2001-270167

Patent Document 2: Tokkaihei 10-290320

In the conventional techniques described in the above, however, there have been the following problems.

That is, in “Printing apparatus and Network Printing system” set forth in Patent Document 1, since the applicable data are limited to the PDL data, there has been a problem that the apparatus or system is lack of flexibility and expandability. Further, according to this conventional technology, since the data of general-purpose image format must be transmitted to the client's personal computer, being a sender of them, the traffics on the network are inevitably increases. In addition, since they are sent back to the sender of the print order irrespective of his intention, he would rather consume much labor and time for handling them.

Further, in “Image-inputting apparatus and Image-inputting method” set forth in Patent Document 2, since there is no storage device to store the printing data converted, the image data should be inputted and converted again even when printing the image same as that previously printed. Accordingly, it is impossible to effectively use the data once created, and also impossible for the computer, etc., coupled the network, to refer them, since the printing data depends on the printer. In addition, according to this conventional technology, only the one-way control of the scanner is possible, resulting in a lack of expandability.

Next, for instance, in “Digital copier” set forth in Patent Document 3 listed later, there is provided at least a pair of the scanner station and the printer station. The scanner station includes the scanner and the network controlling section, while the printer station includes the network communicating section, the data storage and the printer. These are working for communicating the data obtained by applying the expansion/compression processing to the read image data and the controlling information for the image data.

Further, additional information, such as printer use, facsimile use, etc., to be attached to the image data read by the scanner station can be included in the controlling information mentioned above. Still further, the scanner station can inquire the operating status from every printer station, and sends the image data to the printer station having the lowest amount of image data, based on the operating statuses replied.

Still further, for another example, in “Image-processing system” set forth in Patent Document 4 listed later, the image inputting means and the printing means are separately disposed, while they are coupled to each other through the information-transmitting path, such as the network, etc. The image inputting means is provided with the first resolution converting means for converting the resolution of the image data to the predetermined low resolution and the image coding means, while the image printing means is provided with the image encoding means and the second resolution converting means for converting the resolution of the image data to the predetermined level, so as to improve the utilization efficiency rate of the network.

Patent Document 3: Tokkaihei 7-311664

Patent Document 4: Tokkaihei 10-233917

In the conventional techniques described in the above, however, there have been the following problems.

That is, in “Digital copier” set forth in Patent Document 3, since the data format of the data outputted from each scanner station is the bit image compression format, there has been a problem that such the format is lack of versatility.

Further, although it is possible for the scanner station to inquire the operating status from each printer station, it is impossible to perform the handshake operation with the other scanner station, resulting in a lack of flexibility in the whole system.

Still further, in “Image-processing system” set forth in Patent Document 4, since the data format of the data outputted from the image inputting means is the individual format, there has been a problem that such the format is lack of versatility.

### SUMMARY OF THE INVENTION

To overcome the abovementioned drawbacks in conventional image-processing apparatuses and systems, it is a first object of the present invention to provide image-processing apparatus and system, which make it possible to effectively utilize the network environment and the data between apparatuses coupled to each other through network, so as to improve the flexibility and expandability of the system more than ever.

Further, it is a second object of the present invention to provide image-processing system, which make it possible to effectively utilize the network environment, and in which the efficiency and the flexibility of the whole system are improved by communicating the data between apparatuses coupled to each other through network.

Accordingly, to overcome the cited shortcomings, the abovementioned object of the present invention can be attained by image-processing apparatuses and systems described as follow.

(1) An apparatus for processing image data, comprising: an image-reading section to read an image on a document; a network interface to couple the apparatus to a network; and a rasterizer to rasterize the image data so as to output rasterized image data; wherein the image data are scanner data acquired by reading the image on the document by means of a scanner included in the image-reading section, or PDL data inputted through the network interface coupled to the network.

(2) The apparatus of item 1, further comprising: a general-purpose image format converting section to convert the scanner data or the PDL data to data of a same general-purpose image format.

(3) The apparatus of item 2, further comprising: a data storage section to store the data of the general-purpose image format, converted by the general-purpose image format converting section.

(4) A system for processing an image through a network, comprising: an image-processing apparatus that includes: an image-reading section to read an image on a document; a first network interface to couple the image-processing apparatus to the network; and a general-purpose image format converting section to convert scanner data, acquired by reading the image on the document by means of a scanner included in the image-reading section, or PDL data, inputted through the network interface coupled to the network, to data of a same general-purpose image format; and an information-processing apparatus that includes: a second network interface to couple the information-processing apparatus to the network; and a display section to display a reproduced image based on the data of the general-purpose image format.

(5) The system of item 4, further comprising: an image-printing apparatus that includes: a third network interface to couple the image-printing apparatus to the network; and a printing section to print a reproduced image based on the data of the general-purpose image format.

(6) The system of item 5, further comprising: a data-storing apparatus that includes: a fourth network interface to couple the data-storing apparatus to the network; and a data storage section to store the data of the general-purpose image format, converted by the general-purpose image format converting section included in the image-processing apparatus.

(7) A system for processing an image through a network, comprising: a plurality of image-processing apparatuses that are coupled to the network, and each of which includes a rasterizer to rasterize image data, representing the image, so as to output rasterized image data; an image-printing apparatus that is coupled to the network, and that includes an image-forming section to form a reproduced image on a sheet and is coupled to the plurality of image-processing apparatuses through the network; and a grouping section to group the plurality of image-processing apparatuses into at least one group including at least one of the plurality of image-processing apparatuses.

(8) The system of item 7, wherein an image-processing apparatus, being one of the plurality of image-processing apparatuses, includes a group information storing section to store group information including access restricting information, serving as access restriction established between an apparatus included in a group to which the image-processing apparatus belongs and another apparatus included in another group.

(9) The system of item 8, wherein the access restricting information also serves as access restriction established between an apparatus and another apparatus, both arbitrarily extracted from apparatuses coupled to the network irrespective of groups grouped by the grouping section.

(10) The system of item 7, wherein the image-printing apparatus includes a group information storing section to store group information including access restricting information, serving as access restriction established between an apparatus included in a group to which the image-printing apparatus belongs and another apparatus included in another group.

(11) The system of item 10, wherein the access restricting information also serves as access restriction established between an apparatus and another apparatus, both arbitrarily extracted from apparatuses coupled to the network irrespective of groups grouped by the grouping section.

(12) The system of item 7, further comprising: a server that is coupled to the network; wherein the server includes a group information storing section to store group information including access restricting information, serving as access restriction established between an apparatus included in a group and another apparatus included in another group, in respect to every apparatus coupled to the network.

(13) The system of item 12, wherein the access restricting information also serves as access restriction established between an apparatus and another apparatus, both arbitrarily extracted from apparatuses coupled to the network irrespective of groups grouped by the grouping section.

Further, to overcome the abovementioned problems, other image-processing apparatuses and systems, embodied in the present invention, will be described as follow:

(14) An image-processing apparatus, characterized in that

in the image-processing apparatus having an image-reading means for reading an image from a document,

there is provided with a rasterizer that inputs image data and outputs a raster image.

(15) The image-processing apparatus, described in item 14, characterized in that

the image data are scanner data acquired by reading the document image by means of the image-reading means.

(16) The image-processing apparatus, described in item 14, characterized in that

there is further provided with a network interface coupling to a network and the image data are PDL data inputted through the network.

(17) An image-processing apparatus, characterized in that

the image-processing apparatus is provided with:

an image-reading means for reading an image from a document;

a network interface coupling to a network; and

a general-purpose image format converting means for converting both scanner data, acquired by reading the document image by means of the image-reading section, and PDL data, inputted through the network, to general-purpose image format data of a same format.

(18) The image-processing apparatus, described in item 17, characterized in that

there is further provided with a general-purpose image format data storing means for storing the general-purpose image format data converted by the general-purpose image format converting means.

(19) An image-processing system, characterized in that

in the image-processing system that is structured by coupling an image-processing apparatus, an image-printing apparatus, an information-processing apparatus and an image storing apparatus to a network,

the image-processing apparatus has: an image-reading means for reading an image from a document; a network interface coupling to a network; and a general-purpose image format converting means for converting both scanner data, acquired by reading the document image by means of the image-reading section, and PDL data, inputted through the network, to general-purpose image format data of a same format,

an image-printing apparatus has: a network interface coupling to the network; and a general-purpose image format data printing means for printing the general-purpose image format data of the general-purpose image format,

an information-processing apparatus has: a network interface coupling to the network; and a display means for displaying the general-purpose image format data of the general-purpose image format, and

a image storing apparatus has: a network interface coupling to the network; and a general-purpose image format data storing means for storing the general-purpose image format data of the general-purpose image format.

(20) An image-processing system, characterized in that

in the image-processing system in which an image-processing apparatus, having a rasterizing means for rasterizing image data, and an image-printing apparatus, having an image-forming means for forming an image on a sheet, are coupled to each other through a network,

there are provided a plurality of image-processing apparatuses, and a grouping means for grouping the plurality of image-processing apparatuses into at least one group including at least one of the plurality of image-processing apparatuses.

(21) The image-processing apparatus, described in item 20, characterized in that

the image-processing apparatus is provided with a group information storing means for storing group information in which access restricting information, being restriction when an apparatus of a group to which the image-processing apparatus itself belongs accesses to apparatus of another group, are established.

(22) The image-processing apparatus, described in item 21, characterized in that

the image-printing apparatus can also belong to the group, and the image-printing apparatus is provided with a group information storing means for storing group information in which access restricting information, being restriction when an apparatus of a group to which the image-printing apparatus itself belongs accesses to apparatus of another group, are established.

(23) The image-processing apparatus, described in item 21 or item 22, characterized in that

a server apparatus is further coupled to the network, and the server apparatus is provided with a group information storing means for storing group information in which access restricting information, being restriction when an apparatus of a group to which the server apparatus itself belongs accesses to apparatus of another group, are established.

(24) The image-processing apparatus, described in anyone of items 21-23, characterized in that

the access restricting information have restriction when accessing to a specific apparatus irrespective of the groups.

### BRIEF DESCRIPTION OF THE DRAWINGS

Other objects and advantages of the present invention will become apparent upon reading the following detailed description and upon reference to the drawings in which:

FIG. 1 shows a block diagram of a configuration of the image-processing system, including image-processing apparatus embodied in the present invention;

FIG. 2 shows a block diagram of a configuration of the image-processing apparatus shown in FIG. 1;

FIG. 3 shows a block diagram of a configuration of the image-printing apparatus shown in FIG. 1;

FIG. 4 shows a flowchart indicating process steps when printing an image based on the data sent from the information-processing apparatus in the image-processing system shown in FIG. 1;

FIG. 5 shows a flowchart indicating process steps when the image-processing apparatus reads the image on the document and stores the image data, in the image-processing system shown in FIG. 1;

FIG. 6 shows a flowchart indicating process steps when the image-processing apparatus reads the image on the document and prints an image based on the image data, in the image-processing system shown in FIG. 1;

FIG. 7 shows a flowchart indicating process steps when viewing or reading the data of general-purpose image format in the image-processing system shown in FIG. 1;

FIG. 8 shows a flowchart indicating process steps when printing an image based on the data of general-purpose image format, which are already stored in the image-processing system shown in FIG. 1;

FIG. 9 shows a block diagram of a configuration of another image-processing system embodied in the present invention;

FIG. 10 shows a block diagram of a configuration of an image-processing apparatus shown in FIG. 9;

FIG. 11 shows a block diagram of a configuration of an image-printing apparatus shown in FIG. 9;

FIG. 12 shows a block diagram of a configuration of another image-processing system, in which a server is added to the image-processing system shown in FIG. 9;

FIG. 13 shows a flowchart of operating steps of the image-processing system shown in FIG. 9; and

FIG. 14 shows a schematic diagram of an example of restrictions with respect to a processing-request between groups in the image-processing system shown in FIG. 9.

### DETAILED DESCRIPTION OF THE PREFERRED EMBODIMENT

Referring to the drawings, the preferred embodiment of the present invention will be detailed in the following.

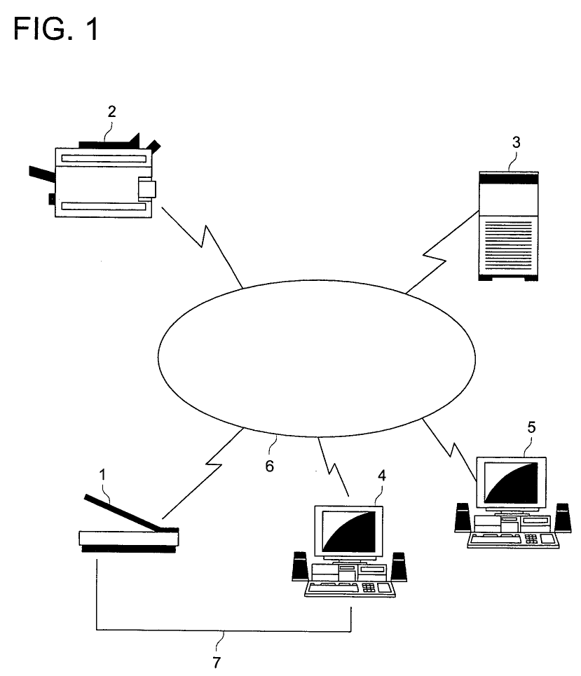

FIG. 1 shows a block diagram of a configuration of the image-processing system, including image-processing apparatus embodied in the present invention.

As shown in FIG. 1, the image-processing system, embodied in the present invention, is so constituted that image-processing apparatus 1, image-printing apparatus 2, image data storing apparatus 3 and information-processing apparatus 4 and information-processing apparatus 5 are coupled to each other through network 6. Further, image-processing apparatus 1 is locally coupled to information-processing apparatus 4 through local communication line 7. For instance, personal computers can be employed as information-processing apparatuses 4 and 5, and it is also possible to employ a personal computer for image data storing apparatus 3, which serves as a database server so to speak.

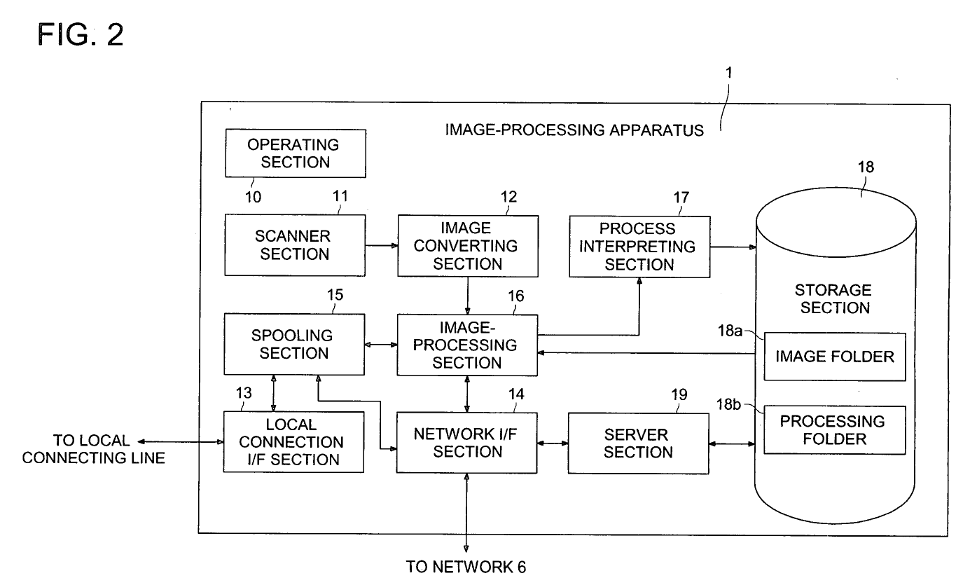

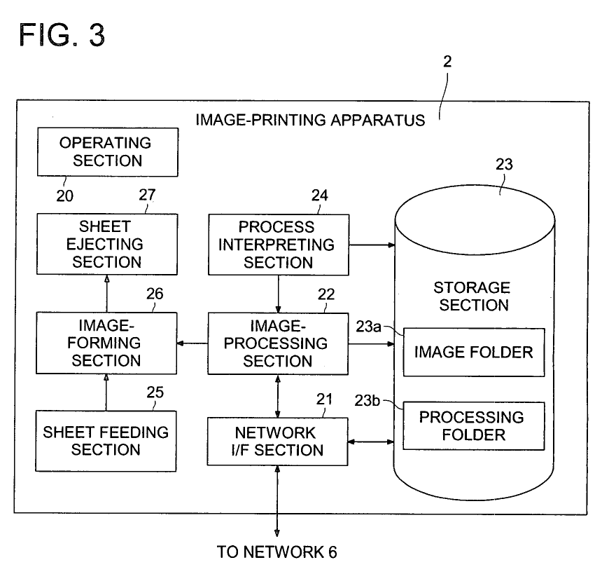

As shown in FIG. 2 detailed later, image-processing apparatus 1 includes scanner section 11 for reading an image from the document, on which the image is recorded, so as to output scanner data, while, as shown in FIG. 3 detailed later, image-printing apparatus 2 includes image-forming section 26 for forming an image on a sheet. It is possible to integrate image-processing apparatus 1 and image-printing apparatus 2 into a single apparatus for practical use, and in this case, it is possible for the single apparatus to realize functions as an image-forming apparatus, such as a digital copier, etc.

FIG. 2 shows a block diagram of the configuration of image-processing apparatus 1 shown in FIG. 1.

As shown in FIG. 2, the configuration of image-processing apparatus 1 includes: operating section 10 that displays information for the user and from which the user inputs operation commands; scanner section 11 that outputs the scanner data by reading an image from the document; image converting section 12 that converts the scanner data outputted from scanner section 31 to PDL data; local connection I/F section 13 serving as an interface for local connecting line 7; network I/F section 14 serving as an interface for network 6; spooling section 15 that temporarily stores the PDL data inputted through local connection I/F section 13 and network I/F section 14; image-processing section 16 that rasterizes the PDL data sent from image converting section 12 and spooling section 15, and further converts the rasterized data to PDF data; process interpreting section 17 that interprets process information attached to the PDF data outputted from image-processing section 16; storage section 18 that stores data sent from process interpreting section 17; and server section 19 that serves as a server of the network system.

In the embodiment shown in FIG. 1, data sent from information-processing apparatus 4 are inputted into image-processing apparatus 1 through local connecting line 7 and local connection I/F section 13, while, data sent from information-processing apparatuses 4 and 5, image data storing apparatus 3 and further image-printing apparatus 2 can be inputted into image-processing apparatus 1 through network 6 and network I/F section 14.

Image-processing section 16 of image-processing apparatus 1 has a function of the rasterizer for rasterizing the image data so as to acquire a raster image. Incidentally, although, in the embodiment of the present invention, the rasterized raster image is converted to the PDF data in image-processing section 16, the present invention is not limited to the PDF data, it is also applicable to convert to data of a certain general-purpose image format. Other than the PDF data, the post script, TIFF, etc. can be cited as the general-purpose image format, and any kind of data format disclosed in the public would be applicable for the present invention.

Next, the operations of process interpreting section 17 will be detailed in the following.

When the image data is inputted from scanner section 11, the user (hereinafter, also referred to as the operator) can input contents of the process to be applied to the image data by means of operating section 10. Then, the inputted process information are attached to the image data, and inputted into process interpreting section 17. Further, the PDL data, inputted through local connection I/F section 13, network I/F section 14, also includes the contents of the process to be applied to the image data, and then, the process information attached to the image data are inputted into process interpreting section 17 as well.

The process information, namely the contents of the process to be applied to the image data, include such information as, for instance, whether or not the printed sheet is punched, whether or not the printed sheets are stapled, whether or not a plurality of images are allotted in a layout within one sheet in the printing operation, etc.

In process interpreting section 17, the image data (PDF data in this embodiment) are stored in image folder 18a of storage section 18 as an image file, and the process information are stored in processing folder 18b of storage section 38 as a processing file. Incidentally, hereinafter, such a combination of the image file and the processing file is defined as a printing JOB.

Incidentally, although, in the embodiment of the present invention, image-processing section 16 converts the PDL data to the data of the general-purpose image format (the PDF data) after image converting section 12 temporarily converts the scanner data outputted from scanner section 11 to the PDL data, the present invention is not limited to the above procedure, it is also applicable to directly convert the scanner data to the data of the general-purpose image format (the PDF data) without temporarily converting to the PDL data.

As described in the above, in the embodiment of the present invention, image-processing apparatus 1 is provided with: scanner section 11 serving as an image reading means for reading the image on the document; image converting section 12 serving as a scanner data converting means for converting the scanner data to PDL data; image-processing section 16 serving as PDL data converting means for converting the PDL data to the data of general-purpose image format; storage section 18 and server section 19, both serving as a file server means for storing the data of general-purpose image format and making it possible to provide the data to others.

In the above configuration, image converting section 12 and image-processing section 16 serve as a general-purpose image format converting means for converting both the scanner data acquired by reading the image on the document by means of the image reading means and the PDL data inputted through the network to the data of the same general-purpose image format.

FIG. 3 shows a block diagram of the configuration of image-printing apparatus 2 shown in FIG. 1.

As shown in FIG. 3, the configuration of image-printing apparatus 2 includes: operating section 20 that displays information for the user and from which the user inputs operation commands; network I/F section 21 serving as an interface for network 6; image-processing section 22 that makes the image file and the processing file inputted through network I/F section 21 stored into storage section 23; storage section 23 including image folder 23a in which the image file is stored and processing folder 23b in which the processing file is stored; process interpreting section 24 that readouts the processing file from processing folder 23b to interpret the contents of the processing file; sheet feeding section 25 that feeds a sheet on which the image is formed; image-forming section 26 that forms the image on the sheet; and sheet ejecting section 27 that ejects the sheet having the image formed by image-forming section 26.

Considering a layout of the images, etc., image-processing section 22 generates an image to be practically formed on the sheet based on the image data outputted from process interpreting section 24, and then, image-forming section 46 forms the image on the sheet.

Since image-printing apparatus 2 handles the data of the general-purpose image format (the PDF data in this embodiment) only when such the data are inputted, and need not to copes with data of another type, such as the PDL data, etc., it is possible to save the cost for handling the data of the other type, resulting in a cost-reduction of the apparatus.

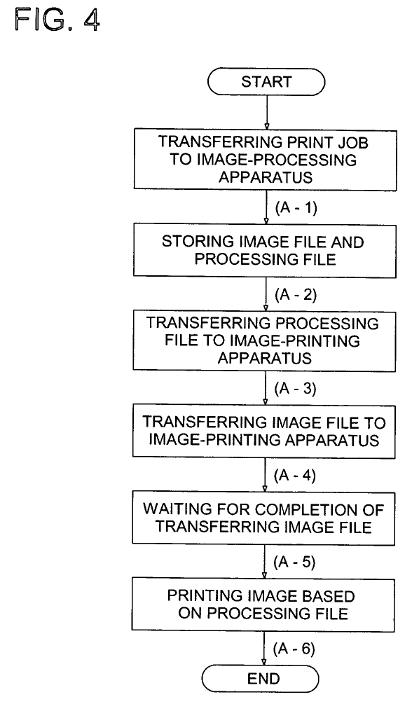

FIG. 4 shows a flowchart indicating the process steps when printing an image based on the data sent from the information-processing apparatus in the image-processing system shown in FIG. 1.

The data sent from information-processing apparatus 4 are transferred to image-processing apparatus 1 through local communication line 7 or network 6, while, the other data sent from information-processing apparatus 5 are transferred to image-processing apparatus 1 through or network 6 (Step A-1). These data are converted to the PDL data by means of application software and the printer driver, which are operated in the information-processing apparatuses 4, 5, and are received as a print job by image-processing apparatus 1.

The received print job is inputted into image-processing section 16 through spooling section 15 to create the abovementioned image file, being the data of general-purpose image format (the PDF data in this embodiment), and the abovementioned processing file including a processing request, a name of the image file, size information of the image file, etc. Then, the image file is stored in image folder 18a, while the processing file is stored in processing folder 18b (Step A-2).

Successively, image-processing apparatus 1 transfers the processing file stored in processing folder 18b to processing folder 23b of image-printing apparatus 2 by employing the general-purpose file transferring protocol, such as the FTP, etc. (Step A-3). The image-printing apparatus 2 recognizes the processing request, the name of the image file, the size information of the image file, etc., based on the contents of the received processing file.

Further, image-processing apparatus 1 transfers the image file stored in image folder 18a to image folder 23a of image-printing apparatus 2 by also employing the general-purpose file transferring protocol, such as the FTP, etc. (Step A-4) . At this time, in case that storing apparatus 3 is designated as the storing destination of the image file, the image file is also sent to storing apparatus 3.

The image-printing apparatus 2 waits a completion of transferring the image file having a file name recognized by the processing file previously received, while monitoring image folder 23a (Step A-5).

When the transferring operation of the image file is completed, image-forming section 26 of image-printing apparatus 2 prints the image in the image file of image folder 23a onto the recording sheet, based on the processing information designated by the processing file of processing folder 23b (Step A-6).

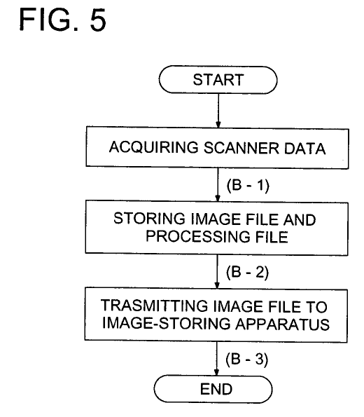

Next, FIG. 5 shows a flowchart indicating the process steps when the image-processing apparatus reads the image on the document and stores the image data, in the image-processing system shown in FIG. 1.

Initially, the user sets the document to be read onto scanner section 11 of image-processing apparatus 1, and inputs a command for reading and storing the image on the document by means of operating section 10. Receiving the command, scanner section 11 acquires the scanner data by reading the image on the document set on it (Step B-1).

Successively, in image-processing apparatus 1, image-converting section 12 converts the scanner data acquired by scanner section 11 to the PDL data, and further, image-processing section 16 converts the PDL data to the data of general-purpose image format (the PDF data). Then, the image file acquired by the abovementioned process is stored into image folder 18a, and the processing file is stored into processing folder 18b (Step B-2).

At this time, in case that storing apparatus 3 is designated as the storing destination of the image file, the image file is also sent to storing apparatus 3 (Step B-3).

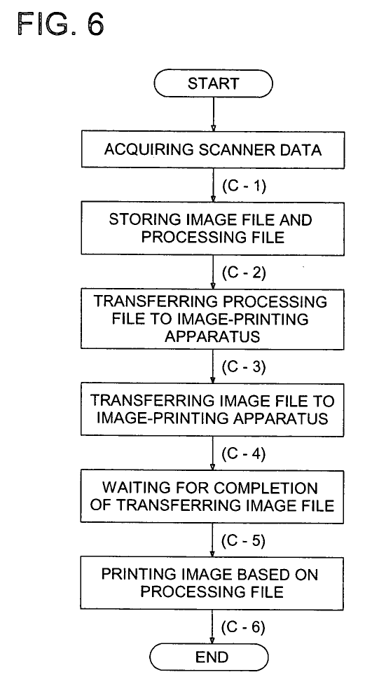

Next, FIG. 6 shows a flowchart indicating the process steps when the image-processing apparatus reads the image on the document and prints an image based on the image data, in the image-processing system shown in FIG. 1.

Initially, the user sets the document to be read onto scanner section 11 of image-processing apparatus 1, and inputs a command for reading and storing the image on the document by means of operating section 10. Receiving the command, scanner section 11 acquires the scanner data by reading the image on the document set on it (Step C-1).

Successively, in image-processing apparatus 1, image-converting section 12 converts the scanner data acquired by scanner section 11 to the PDL data, and further, image-processing section 16 converts the PDL data to the data of general-purpose image format (the PDF data). Then, the image file acquired by the abovementioned process is stored into image folder 18a, and the processing file is stored into processing folder 18b (Step C-2).

Further, image-processing apparatus 1 transfers the processing file stored in processing folder 18b to processing folder 23b of image-printing apparatus 2 by employing the general-purpose file transferring protocol, such as the FTP, etc. (Step C-3). In image-printing apparatus 2, the processing request, the name of the image file, the size information of the image file, etc., are recognized on the basis of the contents of the received processing file.

Further, image-processing apparatus 1 transfers the image file stored in image folder 18a to image folder 23a of image-printing apparatus 2 by employing the general-purpose file transferring protocol, such as the FTP, etc. (Step C-4).

The image-printing apparatus 2 waits a completion of transferring the image file having a file name recognized by the processing file previously received, while monitoring image folder 23a (Step C-5).

When the transferring operation of the image file is completed, image-forming section 26 of image-printing apparatus 2 prints the image in the image file of image folder 23a onto the recording sheet, based on the processing information designated by the processing file of processing folder 23b (Step C-6).

Incidentally, according to the image-processing system embodied in the present invention, since the image data, which were once converted to the general-purpose image format (the PDF data), are already stored in the network, it becomes possible to conduct viewing and printing operations by employing a common filing system, such as NFS (Network File System), etc., without consuming labor hours for reconverting the image data.

In other words, the user can view and/or print the image stored in anyone of apparatuses in the image-processing system as it is, by operating an operating section of anyone of the apparatuses coupled to network 6 of the image-processing system. For this purpose, it is necessary that an application program, which makes it possible to view or read the data of general-purpose image format as it is, is installed into the apparatus having the operating section. For instance, when the data of general-purpose image format are the PDF data, an application program, such as Acrobat reader, Illustrator, Page maker, etc., would make it possible to view or read the data concerned.

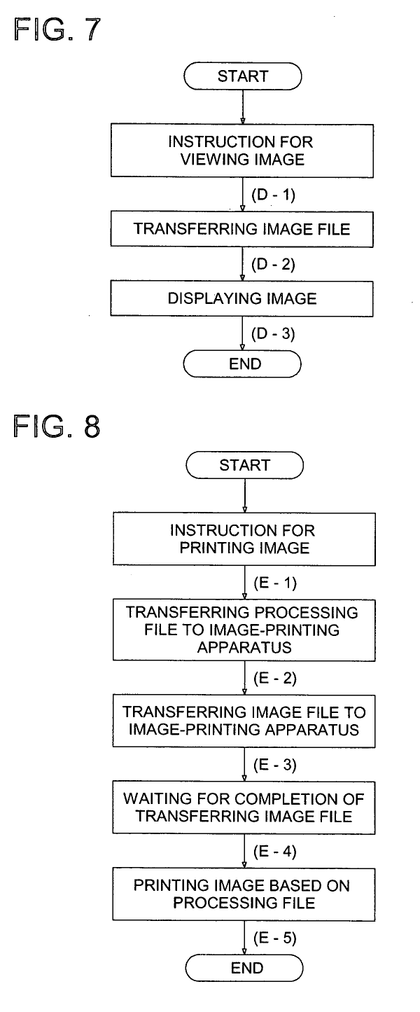

Next, FIG. 7 shows a flowchart indicating the process steps when viewing or reading the data of general-purpose image format in the image-processing system shown in FIG. 1.

The user inputs a command for viewing the image from, for instance, the operating section of information-processing apparatus 4 (Step D-1). The image file designated by the user is transferred to information-processing apparatus 4 (Step D-2) . The image is displayed on the display section of information-processing apparatus 4 by means of the application program installed in information-processing apparatus 4 (Step D-3).

Next, FIG. 8 shows a flowchart indicating the process steps when printing an image based on the data of general-purpose image format, which are already stored in the image-processing system shown in FIG. 1.

The user inputs a command for printing the image from, for instance, the operating section of information-processing apparatus 4 (Step E-1).

In the following, an example in which the image data designated for printing are stored in storage section 18 will be detailed.

The image-processing apparatus 1, which received the command for printing the image from information-processing apparatus 4, transfers the processing file stored in processing folder 18b to processing folder 23b of image-printing apparatus 2 by employing the general-purpose file transferring protocol, such as the FTP, etc. (Step C-3). In image-printing apparatus 2, the processing request, the name of the image file, the size information of the image file, etc., are recognized on the basis of the contents of the received processing file.

Further, image-processing apparatus 1 transfers the image file stored in image folder 18a to image folder 23a of image-printing apparatus 2 by employing the general-purpose file transferring protocol, such as the FTP, etc., as well (Step E-3).

The image-printing apparatus 2 waits a completion of transferring the image file having a file name recognized by the processing file previously received, while monitoring image folder 23a (Step E-4).

When the transferring operation of the image file is completed, image-forming section 26 of image-printing apparatus 2 prints the image in the image file of image folder 23a onto the recording sheet, based on the processing information designated by the processing file of processing folder 23b (Step E-5).

Referring to the drawings, the second embodiment of the present invention will be detailed in the following.

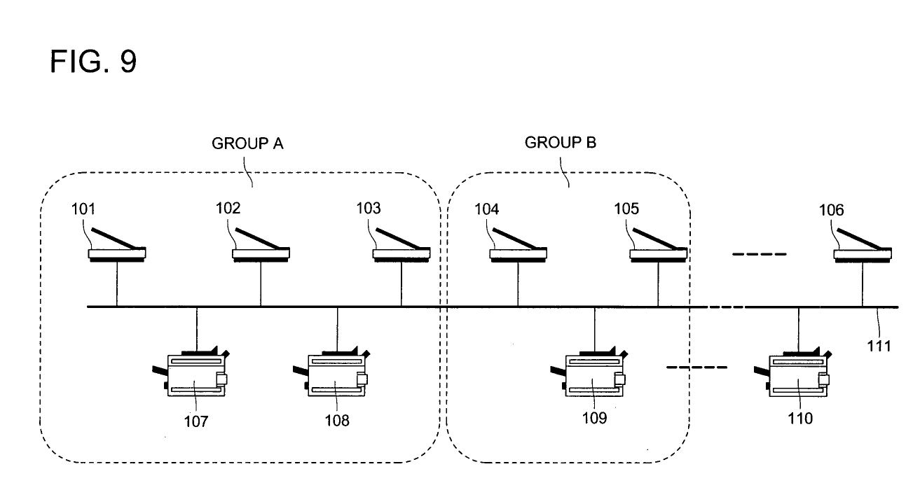

FIG. 9 shows a block diagram of a configuration of the other image-processing system embodied in the present invention.

As shown in FIG. 9, the image-processing system, embodied in the present invention, is so constituted that image-processing apparatuses 101, 102, 103, 104, 105, 106, and image-printing apparatuses 107, 108, 109, 110, are coupled to each other through network 111. Any kind of networks including LAN (Local Area Network), for instance, Ethernet (Registered trade mark), and another kind of Internet, etc. can be employed for network 111.

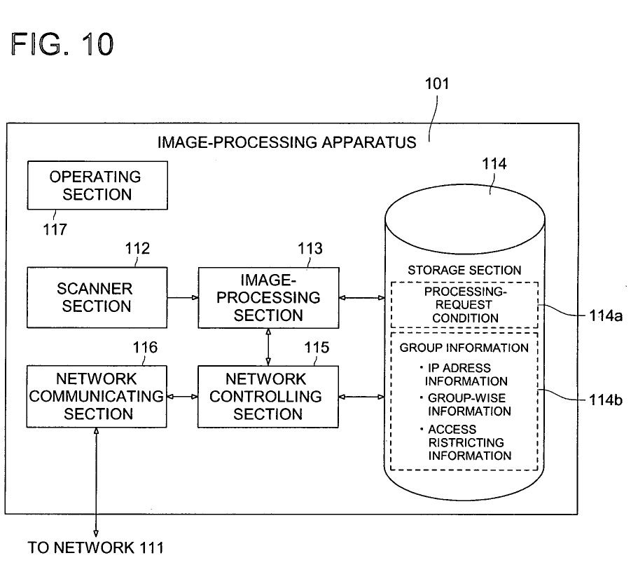

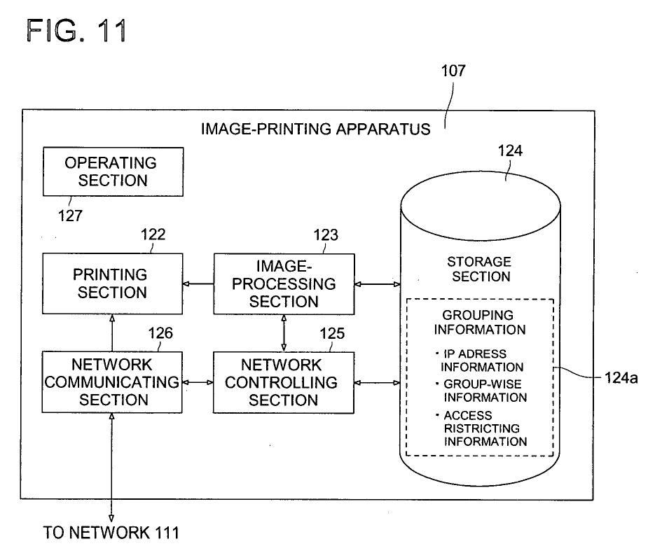

As shown in FIG. 10 detailed later, image-processing apparatuses 101-106 include scanner section 112 for reading an image from the document, on which the image is recorded, so as to output scanner data, while, as shown in FIG. 11 detailed later, image-printing apparatuses 107-110 includes printing section 122 for forming an image on a sheet. It is possible to integrate each of image-processing apparatuses 101-106 and each of image-printing apparatuses 107-110 into a single apparatus for practical use, and in this case, it is possible for the single apparatus to realize functions as an image-forming apparatus, such as a digital copier, etc.

Incidentally, although the image-processing apparatus includes the scanner section and the rasterizer in the abovementioned embodiment, the present invention is not limited to the abovementioned embodiment, but it is also applicable that only the rasterizer is included in the image-processing apparatus. Further, it is acceptable that the image data to be rasterized by the image-processing apparatus are either scanner data read by its own scanner section or other image data inputted from the personal computer through the network.

In the present embodiment, the image-processing apparatuses and the image-printing apparatuses are grouped into plural groups. In the example shown in FIG. 9, image-processing apparatuses 101-103 and image-printing apparatuses 107-108 are categorized in group A, while image-processing apparatuses 104, 105 and image-printing apparatus 109 are categorized in group B. In contrast, existence of the apparatuses, such as image-processing apparatus 106 and image-printing apparatus 110, which are not categorized in any group, is also acceptable.

FIG. 10 shows a block diagram of the configuration of image-processing apparatus 101 shown in FIG. 9.

Incidentally, since the configurations of image-processing apparatuses 101-106 are the same relative to each other, only the configuration of image-processing apparatus 101 will be detailed in the following, as a representative of them.

As shown in FIG. 10, the configuration of image-processing apparatus 101 includes: scanner section 102 that outputs the scanner data by reading an image from the document; image-processing section 113 that controls the operations of the apparatus as a whole and applies image-processing, detailed later, to the scanner data sent from scanner section 102; storage section 114 that stores processing-request condition 114a representing whether or not a processing operation for the image data is requested, and grouping information 114b, which are established when the apparatuses coupled to each other through network 111 are grouped; network controlling section 115 that controls the communicating operations conducted through network 111; network communicating section 116 that conducts practical communications through network 111; and operating section 117 that displays information for the user and from which the user inputs operation commands.

In the embodiment shown in FIG. 9, image-processing apparatus 101 can conduct bilateral data communications with image-processing apparatuses 102-106 and Image-printing apparatuses 107-110 through network communicating section 116. At this time, it is possible to restrict the processing-request depending on whether or not the destination apparatus belongs to the group concerned as detailed later, which group it belongs, etc., based on the group it belongs.

Image-processing section 113 of image-processing apparatus 101 has a function of the rasterizer for rasterizing the image data so as to acquire a raster image. Incidentally, although, in the embodiment of the present invention, the rasterized raster image is converted to the PDF (Portable Document Format; file format for realizing communications with digital documents, developed by Adobe Systems Inc. in United States of America) data in image-processing section 113, the present invention is not limited to the PDF data, it is also applicable to convert to data of a certain general-purpose image format. Other than the PDF data, the post script, TIFF, etc. can be cited as the general-purpose image format, and any kind of data format disclosed in the public would be applicable for the present invention.

It is possible for image-processing apparatus 101 to establish a condition for requesting the rasterization processing of the image data to another image-processing apparatus as processing-request condition 114a to be stored in storage section 114. Alternatively, it is also applicable that the user establishes such the condition by means of operating section 117.

Further, the processing-request conditions could be established corresponding to the current status of the apparatus, and for instance, such the conditions includes:

requesting the rasterization processing to another image-processing apparatus every time when it is necessary,

requesting the rasterization processing to another image-processing apparatus when the rasterization processing cannot be commenced within a predetermined time interval in the apparatus concerned, etc.

Still further, it is also possible to include a processing-request hierarchical condition into processing-request condition 114a. According to the processing-request hierarchical condition, it is possible to establish whether or not the rasterization processing requested by an image-processing apparatus should allow to be further requested to another image-processing apparatus. Accordingly, it becomes possible to avoid a fear of invading a confidentiality of the image data, which might be caused by hierarchically requesting the rasterization processing to plural image-processing apparatuses one by one.

As grouping information 114b to be stored in storage section 114, IP address (a number for identifying a partner currently communicating on the TCP/IP network) of a member in the same group can be registered as IP address information, and a name of the group to which the user belongs can be established as group-wise information, and further, access restrictions between the groups can be established as access restricting information. It is also applicable that the user can conduct the abovementioned establishments and registrations by means of, for instance, operating section 117.

FIG. 11 shows a block diagram of the configuration of image-printing apparatus 107 shown in FIG. 9.

Incidentally, since the configurations of image-printing apparatuses 107-110 are the same relative to each other, only the configuration of image-printing apparatus 107 will be detailed in the following, as a representative of them.

As shown in FIG. 11, the configuration of image-printing apparatus 107 includes: image-printing section 122 that prints an image on a sheet; image-processing section 123 that controls the operations of the apparatus as a whole; storage section 124 that stores grouping information 124a, which are established when the apparatuses coupled to each other through network 111 are grouped, and other data; network controlling section 125 that controls the communicating operations conducted through network 111; network communicating section 126 that conducts practical communications through network 111; and operating section 127 that displays information for the user and from which the user inputs operation commands.

As grouping information 124a to be stored in storage section 124, IP address of a member in the same group can be registered as IP address information, and a name of the group to which the user belongs can be established as group-wise information, and further, access restrictions between the groups can be established as access restricting information. It is also applicable that the user can conduct the abovementioned establishments and registrations by means of, for instance, operating section 127.

Since image-printing apparatus 2 handles the data of the general-purpose image format (the PDF data in this embodiment) only when such the data are inputted, and need not to copes with data of another type, such as the PDL (Page Description Language, which can be interpreted by the image-printing apparatus by means of software called as an application program or a printer driver) data, etc., it is possible to save the cost for handling the data of the other type, resulting in a cost-reduction of the apparatus.

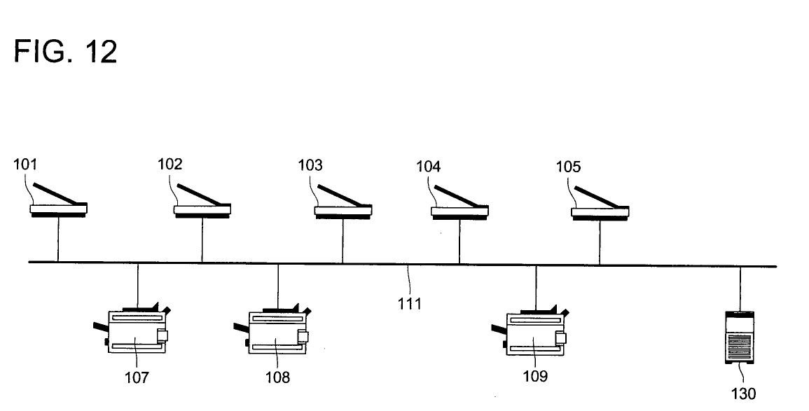

FIG. 12 shows a block diagram of a configuration of another image-processing system, in which a server is added to the image-processing system shown in FIG. 9.

In the configuration shown in FIG. 9, although the processing-request condition and the grouping information are established for each of the image-processing apparatuses and for each of the image-printing apparatuses, those information can be not only established for each of the apparatuses, but also established in DHCP (Dynamic Host Configuration Protocol, which automatically allots information necessary for activating the computer) server 130 as a whole.

In this case, each of the apparatuses tries to acquire the IP address from DHCP server 130. At this time, DHCP server 130 refers to the grouping information established in advance in it, corresponding to MAC Address (Media Access Control Address, which is a physical address of 12 figures attached to an Ethernet (registered trade mark) board, etc.) of the apparatus currently requesting the acquisition of the IP address, and then, transmits the IP address and the grouping information, corresponding to the MAC Address concerned, to the apparatus concerned. Based on the transmitted data of the IP address and the grouping information, each of the apparatuses establishes the group-wise information.

Incidentally, although the DHCP server is exemplified as the server coupled to the network in the abovementioned embodiment of the present invention, the present invention is not limited to the above. The server could be a DNS (Domain Names System, which teaches the host IP address based on the name of the host apparatus) server, a printer server, a main image-printing apparatus (regarded as a host apparatus), a main printing apparatus (regarded as a host apparatus), etc.

Further, although the MAC Address is referred in the abovementioned embodiment of the present invention, the present invention is not limited to the above. An apparatus ID number, an apparatus name, a IP address, etc. are also applicable for this purpose, depending on a kind of the grouping information to be established.

Still further, although a single server is indicated in FIG. 12, the present invention is not limited to the above. Of course, plural servers would be applicably installed in the system.

Next, operations of the present embodiment will be detailed in the following.

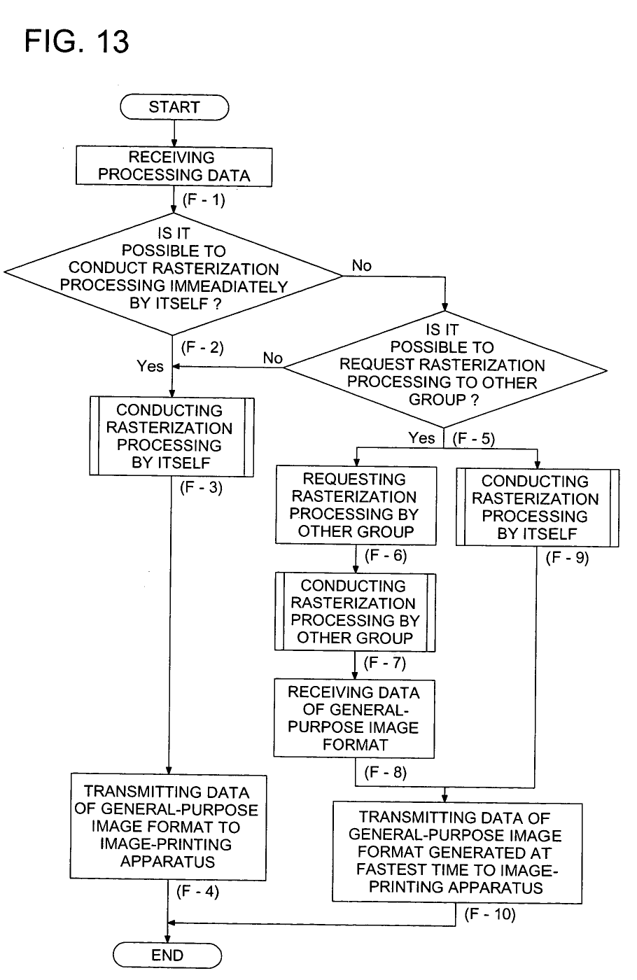

FIG. 13 shows a flowchart of the operating steps of the image-processing system shown in FIG. 9.

In the following, the operating steps when image-printing apparatus 109 (group B) prints out an image based on the image data inputted into image-processing apparatus 104 (group B) shown in FIG. 9 will be detailed.

Normally, the image data inputted into image-processing apparatus 104 (Step F-1) is rasterized in image-processing apparatus 104 itself (Step F-3), and converted to the data of general-purpose image format, which are transmitted to image-printing apparatus 109 of the same group (Step F-4).

However, in such a case, for instance, that image-processing apparatus 104 is in mid-course of rasterizing other image data previously transmitted to it, and has no room for rasterizing the image data newly inputted in it (based on processing-request condition 114a of storage section 114) when the image data are inputted into image-processing apparatus 104 (Step F-2), image-processing apparatus 104 requests the rasterization processing of the image data concerned on the multicast base to image-processing apparatuses of the group A, being a different group of image-processing apparatus 104, which is established in advance as a rasterization processing request-able group by the IP address in the image-processing apparatus (based on the access restricting information of grouping information 114b of storage section 114) (Step F-S), while waiting for commencement of the rasterization processing in image-processing apparatus 104 itself (Step F-9).

Among the image-processing apparatuses of the group A, which receives the request of rasterization processing, only a specific image-processing apparatus, still having a room for the rasterization processing, performs the rasterization processing of the image data, and transmits the converted data of general-purpose image format to image-processing apparatus 104 being an original sender of the image data (Step F-8).

The image-processing apparatus 104 transmits the data of general-purpose image format, which is generated at the fastest time, either by itself or by the specific image-processing apparatus of other group, to image-printing apparatus 109 within the same group.

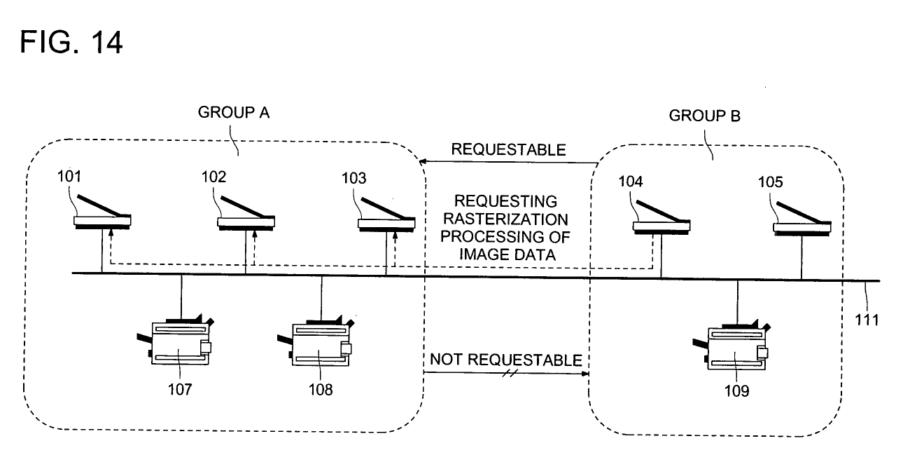

FIG. 14 shows a schematic diagram of an example of restrictions with respect to a processing-request between groups in the image-processing system shown in FIG. 9.

In the example shown in FIG. 14, since the accessing right from group B to group A is allowed, image-processing apparatuses 104, 105 of group B can request the rasterization processing to the image-processing apparatuses of group A as needed. However, since the accessing right from group A to group B is not allowed, none of the image-processing apparatuses of group A can request the rasterization processing to the image-processing apparatuses of group B.

Although only the unilateral accessing right is allowed in the example shown in FIG. 14, this accessing right can be flexibly established as needed, such as allowance of bilateral requesting practice, ban of bilateral requesting practice, etc.

In the abovementioned embodiment, although another group is established in advance as the rasterization processing request-able group in the image-processing apparatus, this establishment can be flexibly achieved, such as, in a unit of group, with respect to a specific image-processing apparatus in the same or other groups, etc.

Further, when each of the image-processing apparatuses has plural groups or a plurality of image-processing apparatuses as the rasterization processing request-able object, it is possible to establish a priority order of them.

As detailed in the foregoing, according to the present invention, the following effects can be attained.

(1) It becomes possible to effectively utilize the network environment and the data between apparatuses coupled to each other through network, so as to improve the flexibility and expandability of the system more than ever.

(2) When the image-processing apparatus having the scanner section conduct the converting operation of the data from the other format to the general-purpose image format, it becomes possible to handle the PDL data and the scanner data as the same data without considering that the formats of the PDL data and the scanner data are different from each other.

(3) In order to conduct the converting operation of the data from the other format to the general-purpose image format, it becomes possible for the other apparatus, coupled to the network, to easily refer the image concerned.

(4) Since the data of general-purpose image format can be stored in the storing apparatus, it becomes possible to shorten the printing time by reusing the data stored in the storing apparatus when printing the image based on the same data, that is, the conversion time to the general-purpose image format can be omitted.

(5) It becomes possible to improve the efficiency and the flexibility of the whole system by effectively utilizing the network environment, and by communicating the data between apparatuses coupled to each other through network.

(6) Since the image-processing apparatus for conducting the reading operation and the image-printing apparatus for conducting the printing operation are separately disposed, it becomes possible to flexibly expand the system and to increase or decrease the number of various apparatuses as needed.

(7) It becomes possible to effectively conduct the rasterizing operation by performing the handshake operations between the image-processing apparatuses.

(8) Since the apparatuses constituting the image-processing system can be grouped and the access restrictions between groups can be established and conducted, the system management can be simplified. In addition, by grouping the apparatuses, it is possible to prevent the image-processing apparatuses from being excessively occupied, resulting in an effective distributed system.

(9) By arranging an image-processing apparatus having a high processing capability and another image-processing apparatus having a low processing capability in the same group, it becomes possible to improve the system-balance of the whole image-processing system, resulting in a cost reduction of the system.

(10) Since the group requested to perform a heavy-loaded processing can effectively utilize the resources owned by the other group by establishing the access restrictions between groups, it becomes possible to improve the utilization efficiency of the system.

Disclosed embodiment can be varied by a skilled person without departing from the spirit and scope of the invention.

What is claimed is:

1. An apparatus for processing image data, comprising:
an image-reading section to read an image on a document;
a network interface to couple said apparatus to a network; and
a rasterizer to rasterize said image data so as to output rasterized image data;
wherein said image data are scanner data acquired by reading said image on said document by means of a scanner included in said image-reading section, or PDL data inputted through said network interface coupled to said network.

2. The apparatus of claim 1, further comprising:
a general-purpose image format converting section to convert said scanner data or said PDL data to data of a same general-purpose image format.

3. The apparatus of claim 2, further comprising:
a data storage section to store said data of said general-purpose image format, converted by said general-purpose image format converting section.

4. A system for processing an image through a network, comprising:
an image-processing apparatus that includes: an image-reading section to read an image on a document; a first network interface to couple said image-processing apparatus to said network; and a general-purpose image format converting section to convert scanner data, acquired by reading said image on said document by means of a scanner included in said image-reading section, or PDL data, inputted through said network interface coupled to said network, to data of a same general-purpose image format; and
an information-processing apparatus that includes: a second network interface to couple said information-processing apparatus to said network; and a display section to display a reproduced image based on said data of said general-purpose image format.

5. The system of claim 4, further comprising:
an image-printing apparatus that includes: a third network interface to couple said image-printing apparatus to said network; and a printing section to print a reproduced image based on said data of said general-purpose image format.

6. The system of claim 5, further comprising:
a data-storing apparatus that includes: a fourth network interface to couple said data-storing apparatus to said network; and a data storage section to store said data of said general-purpose image format, converted by said general-purpose image format converting section included in said image-processing apparatus.

7. A system for processing an image through a network, comprising:
a plurality of image-processing apparatuses that are coupled to said network, and each of which includes a rasterizer to rasterize image data, representing said image, so as to output rasterized image data;
an image-printing apparatus that is coupled to said network, and that includes an image-forming section to form a reproduced image on a sheet and is coupled to said plurality of image-processing apparatuses through said network; and
a grouping section to group said plurality of image-processing apparatuses into at least one group including at least one of said plurality of image-processing apparatuses.

8. The system of claim 7,
wherein an image-processing apparatus, being one of said plurality of image-processing apparatuses, includes a group information storing section to store group information including access restricting information, serving as access restriction established between an apparatus included in a group to which said image-processing apparatus belongs and another apparatus included in another group.

9. The system of claim 8,
wherein said access restricting information also serves as access restriction established between an apparatus and another apparatus, both arbitrarily extracted from apparatuses coupled to said network irrespective of groups grouped by said grouping section.

10. The system of claim 7,
wherein said image-printing apparatus includes a group information storing section to store group information including access restricting information, serving as access restriction established between an apparatus included in a group to which said image-printing apparatus belongs and another apparatus included in another group.

11. The system of claim 10,
wherein said access restricting information also serves as access restriction established between an apparatus and another apparatus, both arbitrarily extracted from apparatuses coupled to said network irrespective of groups grouped by said grouping section.

12. The system of claim 7, further comprising:
a server that is coupled to said network;
wherein said server includes a group information storing section to store group information including access restricting information, serving as access restriction established between an apparatus included in a group and another apparatus included in another group, in respect to every apparatus coupled to said network.

13. The system of claim 12,
wherein said access restricting information also serves as access restriction established between an apparatus and another apparatus, both arbitrarily extracted from apparatuses coupled to said network irrespective of groups grouped by said grouping section.
